(19) United States
(12) Patent Application Publication
(10) Pub. No.: US 2003/0122822 A1
(43) Pub. Date: Jul. 3, 2003

(54) Method and apparatus for performing setup and shading stages in computer graphics

(76) Inventor: Chung-Yen Lu, Hsinchu (TW)

Correspondence Address: BIRCH STEWART KOLASCH & BIRCH, PO BOX 747, FALLS CHURCH, VA, 22040-0747, US

(21) Appl. No.: 10/252,567

(22) Filed: Sep. 24, 2002

(30) Foreign Application Priority Data
Dec. 28, 2001 (TW) 90133024

(51) Int. Cl. G06T 15/60

(52) U.S. Cl. 345/426

(57) ABSTRACT

A setup/shading device for performing a shading process in respect to a plurality of triangles. It includes a shading coordinate generator, a common term setup unit and a plurality of attribute setup/shading units. The shading coordinate generator produces coordinates of the pixels contained in a current triangle. The common term setup unit is used to determine common term data contained in the coefficients of the plane equations. The attribute setup/shading units each include first and second hardware circuits and are operated in a first mode or a second mode. In the first mode, the two hardware circuits cooperate to calculate the attribute values of the pixels by absolute shading. In the second mode, the second hardware circuit calculates the attribute values of the pixels by relative shading and the first hardware circuit calculates the coefficients of the plane equation corresponding to a next triangle subsequent to the current triangle.

### BACKGROUND OF THE INVENTION

1. Field of the Invention

The present invention relates to a computer graphics technology, more specifically, to a method and apparatus for processing setup and shading stages in the rendering process of computer graphics.

2. Description of the Prior Art

Rendering in computer graphics is a process of converting from a database representation of a three-dimensional object to a shaded two-dimensional projection on a view surface. It involves a number of separate processes, such as setting up a polygon model, processing visible and invisible surfaces of the polygon model and shading the pixels of the polygon. The present invention focuses on the shading process in computer graphics. One of the popular shading methods is called the Gouraud shading method developed by Gouraud, which adopts the intensity-interpolation scheme to render a polygon surface by linearly interpolating intensity values across the surface.

A polygon surface can be divided into a number of non-overlapping triangles, each of rendered in many attributes such as red, green, blue, and so on. All of the attributes are calculated at every pixel within the triangle. In addition, each of the attributes has a dedicated attribute surface, generally described by a plane equation. The plane equations pertaining to these attributes can be expressed by the attribute values of three vertices of the triangle. In the following discussion, the three vertices of a triangle are denoted by V₀, V₁ and V₂.

The attributes of a triangle generally include color components, depth information, blending factors and texture coordinates. The color components preferably consist of red, green, blue, specular red, specular green and specular blue, denoted by R, G, B, SR, SG and SB, respectively. The blending factors preferably include alpha and fog factors, denoted by A and F. The depth information includes parameters Z and W. The texture coordinates may include several sets of (U, V). For example, if there are four sets of texture coordinates, they are represented by (UA, VA), (UB, VB), (UC, VC) and (UD, VD). The attribute set Λ is denoted by {R, G, B, A, Z, W, F, SR, SG, SB, UA, VA, UB, VB, UC, VC, UD, VD} and any attribute belonging to a vertex Vᵢ (i=1, 2 or 3) is denoted by Λᵢ.

The plane equation pertaining to attribute Λ can be expressed as:

Λ(x,y)=a_{Λ}(x−x_{ref})+b_{Λ}(y−y_{ref})+Λ_{ref} (1)

where

$$\begin{matrix}{a}_{Λ} = \frac{\vert \begin{matrix}{Λ}_{0} & {y}_{0} & 1 \\ {Λ}_{1} & {y}_{1} & 1 \\ {Λ}_{2} & {y}_{2} & 1\end{matrix} \vert}{Δ} , & ( 2 ) \\ \begin{matrix}{b}_{Λ} = \frac{\vert \begin{matrix}{x}_{0} & {Λ}_{0} & 1 \\ {x}_{1} & {Λ}_{1} & 1 \\ {x}_{2} & {Λ}_{2} & 1\end{matrix} \vert}{Δ} , & \end{matrix} & ( 3 ) \\ Δ = \vert \begin{matrix}{x}_{0} & {y}_{0} & 1 \\ {x}_{1} & {y}_{1} & 1 \\ {x}_{2} & {y}_{2} & 1\end{matrix} \vert . & ( 4 )\end{matrix}$$

In addition, Λ_{ref} is the attribute value at a reference pixel (x_{ref}, y_{ref}). The coordinates (x₀, y₀), (x₁, y₁) and (x₂, y₂) denote the coordinates of the vertices V₁, V₂ and V₃ of the triangle.

A typical shading process for rendering an attribute surface of a triangle is described as follows:

(1) Receiving attribute data Λ₁, Λ₂ and Λ₃ of the vertices (x₀, y₀), (x₁, y₁) and (x₂, y₂) of the triangle;

(2) Calculating the coefficients a_{Λ} and b_{Λ} of the plane equation of attribute Λ; and

(3) Linearly interpolating the attribute values of interior pixels within the triangle.

Traditionally, step (2) is referred to as a “setup” stage and step (3) is referred to as a “shading” stage. In conventional render engines, a central setup circuit is designated for preparing the coefficients of all plane equations and a plurality of shading circuits are designed to generate the attribute values of the pixels within the triangle in respect to these attribute surfaces. FIG. 1 (Prior Art) is a block diagram of a setup/shading device of a conventional render engine. In FIG. 1, the setup/shading device includes a setup circuit 10, a shading circuit 20 and a shading coordinate generator 30. The setup circuit 10 receives the vertex coordinates (x₀, y₀), (x₁, y₁) and (x₂, y₂) of the triangle and their attribute values (R₀, R₁, R₂)˜(VD₀, VD₁, VD₂) and generates coefficients (a_{R}, b_{R}, R_{ref})˜(a_{VD}, b_{VD}, R_{VD}) of the plane equations of all attributes, where R_{ref}˜VD_{ref} denote the attribute values at a reference pixel (x_{ref}, y_{ref}). The reference pixel can be set as any point within the triangle, including the vertices. In addition, shading coordinate generator 30 sequentially outputs the coordinates (x, y) of all of the pixels according to the scope of the triangle defined by its vertices (x₀, y₀), (x₁, y₁) and (x₂, y₂). The shading circuit 20 includes a plurality of attribute shading units corresponding to the attributes (not shown) for sequentially producing all of the attribute values R(x, y)˜VD(x, y) of the pixel coordinates (x, y) provided by the shading coordinate generator 30 according to the coefficients of the plane equations of the attributes.

Furthermore, the generic coefficients a_{Λ} and b_{Λ} of the plane equation of attribute Λ can be expressed as follows:

$$\begin{matrix}{a}_{Λ} = \frac{\vert \begin{matrix}{Λ}_{0} & {y}_{0} & 1 \\ {Λ}_{1} & {y}_{1} & 1 \\ {Λ}_{2} & {y}_{2} & 1\end{matrix} \vert}{Δ} = {k}_{11} ( {Λ}_{1} - {Λ}_{0} ) + {k}_{12} ( {Λ}_{2} - {Λ}_{0} ) & ( 5 ) \\ {b}_{Λ} = \frac{\vert \begin{matrix}{x}_{0} & {Λ}_{0} & 1 \\ {x}_{1} & {Λ}_{1} & 1 \\ {x}_{2} & {Λ}_{2} & 1\end{matrix} \vert}{Δ} = {k}_{21} ( {Λ}_{1} - {Λ}_{0} ) + {k}_{22} ( {Λ}_{2} - {Λ}_{0} ) & ( 6 ) \\ where {k}_{11} = \frac{( {y}_{2} - {y}_{0} )}{Δ} , {k}_{12} = - \frac{( {y}_{1} - {y}_{0} )}{Δ} , {k}_{21} = - \frac{( {x}_{2} - {x}_{0} )}{Δ} , & ( 7 ) \\ {k}_{22} = \frac{( {x}_{1} - {x}_{0} )}{Δ} . & \end{matrix}$$

Thus, k₁₁, k₁₂, k₂₁ and k₂₂ are constants for computing coefficients of the plane equations corresponding to the attribute surfaces of a triangle. Thus, the common terms k₁₁, k₁₂, k₂₁ and k₂₂ can be calculated in advance and distributed to the setup circuits with respect to various attributes.

FIG. 2 (Prior Art) is a block diagram of a setup/shading device of a conventional render engine utilizing the distributed architecture. The difference between the device structures of FIG. 1 and FIG. 2 is in the setup circuit. As shown in FIG. 2, the setup circuit 10 in FIG. 1 is replaced by a common term setup unit 12 and a setup circuit 14 composed of a plurality of specific setup units 140 with respect to various attributes. The common term setup unit 12, according to equation (7), determines common terms k₁₁, k₁₂, k₂₁ and k₂₂ using the vertex coordinates (x₀, y₀), (x₁, y₁) and (x₂, y₂). These common terms are sent to the setup circuit 14. The specific setup units 140 each receive these common terms k₁₁, k₁₂, k₂₁ and k₂₂ and one set of the attribute values (R₀, R₁, R₂)˜(VD₀, VD₁, VD₂) and generate the corresponding set of the plane equation coefficients (a_{R}, b_{R}, R_{ref})˜(a_{VD}, b_{VD}, VD_{ref}), where the attribute values with an index “ref” are the attribute values of a reference pixel (x_{ref}, y_{ref}). In addition, shading coordinate generator 30 sequentially outputs the coordinates (x, y) with respect to all of the pixels according to the scope of the triangle defined by its vertices (x₀, y₀), (x₁, y₁) and (x₂, y₂). The shading circuit 20 includes a plurality of attribute shading units 200 for sequentially producing all of the attribute values R(x, y)˜VD(x, y) of the pixel coordinates (x, y) provided by the shading coordinate generator 30 according to the coefficients of the plane equations of the attributes. Since the coefficients of the plane equations are computed in parallel, the conventional distributed setup scheme obtains a higher polygon rate than that of FIG. 1.

### SUMMARY OF THE INVENTION

The object of the present invention is to provide a novel method and apparatus of processing the setup/shading stages for simplifying the circuitry of the conventional distributed setup scheme, thereby reducing the cost in design and achieving superior graphics performance.

The present invention achieves the above-indicated objects by providing a setup/shading device for performing the setup/shading stages of a shading process in respect to a plurality of attributes of graphical objects, such as the triangles constituting a polygon. These attributes can be color components, depth information, blending factors and texture coordinates. Attribute values of the pixels contained in a graphical object in respect to an attribute can be determined by an attribute plane equation, generally defined by its coefficients (a_{Λ}, b_{Λ} and Λ_{ref}). The setup/shading device includes a shading coordinate generator, a common term setup unit and an attribute setup/shading unit. The shading coordinate generator is used to sequentially produce coordinates of the pixels contained in the graphical object, for example, to send all the coordinates of the pixels of the graphical object (regular shading) or to send the coordinate of a pixel within each of the blocks (block shading). The common term setup unit is used to determine a plurality of common term data k₁₁, k₁₂, k₂₁, and k₂₂, independent of the attribute, contained in the coefficients of the plane equation. The attribute setup/shading unit is used to calculate the coefficients of the plane equation based on the common term data and calculating the attribute values of the pixels corresponding to the coordinates received from the shading coordinate generator based on the plane equation using the same hardware circuitry under the control of a plurality of multiplexers. Such a setup/shading device can utilize the shading circuitry to perform a portion of the setup operation, which simplifies the conventional distributed architecture.

In addition, the present invention also provides a setup/shading device for performing the setup/shading stages of a shading process in respect to a plurality of attributes of graphical objects. The setup/shading device includes a shading coordinate generator, a common term setup unit and an attribute setup/shading unit. The shading coordinate generator is used to sequentially produce coordinates of the pixels contained in a first graphical object. The common term setup unit is used to determine first common term data and second common term data, independent of the attribute, contained in coefficients of the first plane equation and coefficients of the second plane equation corresponding to a second graphical object subsequent to the first graphical object. The attribute setup/shading unit, including a first hardware circuit and a second hardware circuit, is used to calculate the coefficients of the first and second plane equations based on the first and second common term data, respectively, and to calculate the attribute values of the pixels corresponding to the coordinates received from the shading coordinate generator based on the first plane equation. The attribute setup/shading unit is operated in a first mode (absolute shading), in which the first hardware circuit and the second hardware circuit calculate the attribute values of the pixels of the first graphical object, or a second mode (relative shading), in which the second hardware circuit calculates the attribute values of the pixels of the first graphical object and the first hardware circuit calculates the coefficients of the second plane equation corresponding to the second graphical object.

In addition, the present invention also provides a setup/shading device, which applies the block shading scheme to the conventional shading device with distributed architecture. The setup/shading device includes a shading coordinate generator, a setup circuit and a plurality of attribute shading units. The shading coordinate generator is used to sequentially produce coordinates of at least one of the pixels allotted in each of a plurality of blocks within the graphical object. The setup circuit is used to determine coefficients of the plane equation. The attribute shading unit is used to calculate the attribute values of the pixels corresponding to the coordinates received from the shading coordinate generator based on the plane equation and calculating the attribute values of other pixels in the blocks by a relative shading procedure.

In addition, the present invention also provides a method of performing a shading process in respect to an attribute of a first graphical object for determining attribute values of pixels within the first graphical object based on a first plane equation corresponding to the attribute. First, coordinates of at least an initial pixel of the pixels contained in the first graphical object is prepared. Next, common term data independent of the attribute contained in coefficients of a second plane equation corresponding to a second graphical object subsequent to the first graphical object is also prepared. Then the attribute value of the initial pixel is determined by the coordinates of the initial pixel and the first plane equation corresponding to the first graphical object by an absolute shading procedure. Finally, the attribute values of the pixels of the first graphical object except for the initial pixel and the coefficients of the second plane equation, can be simultaneously calculated by the attribute value of the initial pixel using a relative shading procedure and by the common term data, respectively.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 (Prior Art) is a block diagram of a setup/shading device of a conventional render engine;

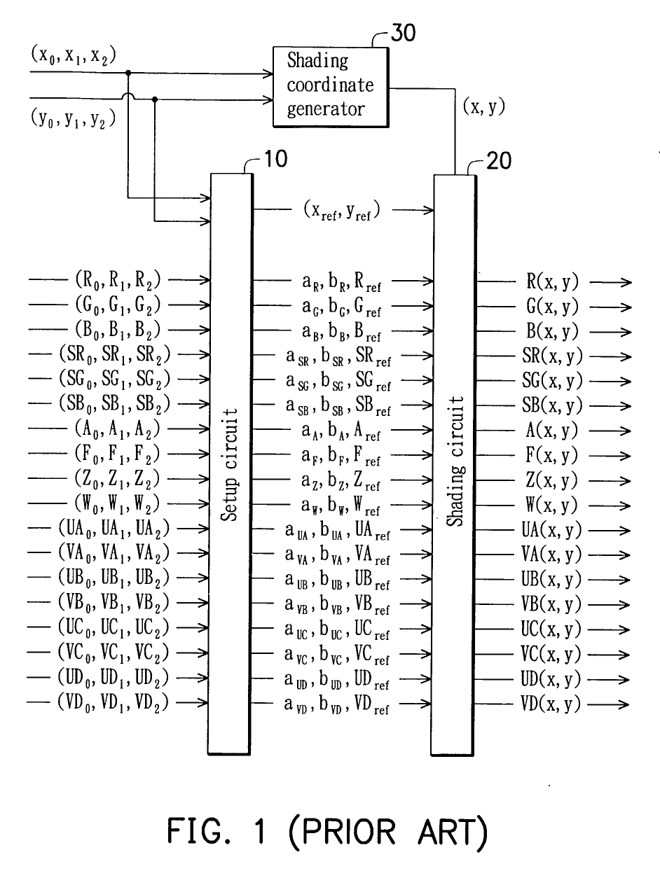

FIG. 2 (Prior Art) is a block diagram of a setup/shading device of a conventional render engine utilizing the distributed architecture;

FIG. 3 is a block diagram of a setup/shading device in accordance with the first embodiment of the present invention;

FIG. 4 is a block diagram of the attribute setup/shading unit in the first embodiment of the present invention;

FIG. 5 is a circuit diagram of the computation unit shown in FIG. 4;

FIG. 6 is a flowchart illustrating the operation of the attribute setup/shading unit in accordance with the first embodiment of the present invention;

FIG. 7 is a circuit diagram of an attribute shading unit in accordance with the second embodiment of the present invention;

FIG. 8 is a block diagram of the attribute setup/shading unit in the second embodiment of the present invention;

FIG. 9 is a circuit diagram of the computation unit shown in FIG. 8; and

FIG. 10 is a flowchart illustrating the operation of the attribute setup/shading unit in accordance with the second embodiment of the present invention.

### DETAILED DESCRIPTION OF THE INVENTION

First Embodiment:

The apparatus of performing the setup/shading stages in the present invention utilizes the resource of the shading circuit to calculate the coefficients of the plane equations pertaining to the next triangle to be processed. In other words, the shading circuit can share a portion of the workload of the conventional setup circuit to reduce the implementation cost of the conventional distributed setup scheme.

The plane equation of attribute Λ with respect to a triangle in the shading process can be expressed as:

Λ(x,y)=a_{Λ}(x−x_{ref})+b_{Λ}(y−y_{ref})+Λ_{ref} (8)

In the following discussion, the reference point (x_{ref}, y_{ref}) and its attribute value Λ_{ref} are set as one of the vertices (x₀, y₀) and their attribute value Λ₀. In addition, Λ ∈ {R, G, B, A, Z, W, F, SR, SG, SB, UA, VA, UB, VB, UC, VC, UD, VD}.

In equation (8), the calculation of the attribute value Λ(x, y) needs two subtraction operations, two multiplication operations and two addition operations. However, if the attribute value pertaining to a certain pixel is known, the number of these arithmetic operations can be reduced. For example, if the calculation of the attribute value Λ(x, y) of a pixel (x, y) is completed, the attribute values pertaining to its adjacent pixels can be calculated by:

Pixel (x+1, y): Λ(x+1,y)=Λ(x,y)+a_{Λ} (9)

Pixel (x, y+1): Λ(x,y+1)=Λ(x,y)+b_{Λ} (10)

Pixel (x−1, y): Λ(x−1,y)=Λ(x,y)−a_{Λ} (11)

Pixel (x, y−1): Λ(x,y−1)=Λ(x,y)−b_{Λ} (12)

According to the above equations, the calculation of the attribute value of an adjacent pixel can be simplified to be one addition or subtraction. Thus, there are two shading styles in an attribute shading circuit of the present embodiment: one is referred to as “absolute shading” described by equation (8) and the other one is referred to as “relative shading” described by equations (9)˜(12). It is noted that the essential hardware building blocks of an attribute shading circuit still include four adders and two multipliers, used to perform the absolute shading procedure. However, when the attribute shading circuit performs relative shading, some multipliers and adders are not used. Thus, the present invention uses this unused resource to process the setup stage pertaining to the next triangle to be processed.

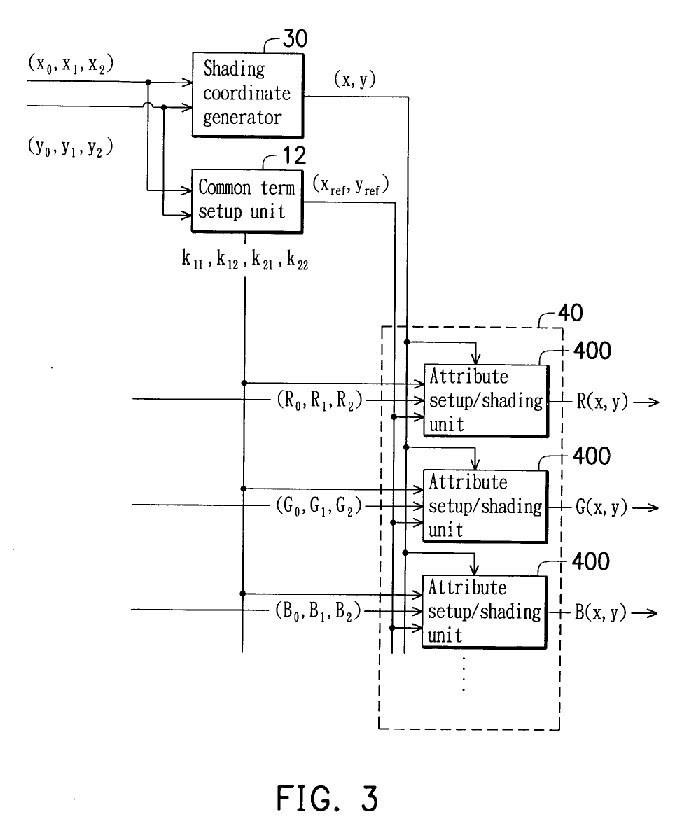

FIG. 3 is a block diagram of a setup/shading device in accordance with the first embodiment of the present invention. As shown in FIG. 3, the setup/shading device includes a shading coordinate generator 30, a common term setup unit 12 and a shading circuit 40. The shading circuit 40 includes a plurality of attribute setup/shading units 400 for processing various attributes.

In the first embodiment, the shading coordinate generator 30 receives the vertex coordinates (x₀, y₀), (x₁, y₁) and (x₂, y₂) of a triangle and sequentially outputs the coordinates of pixels (x, y) within the triangle. The common term setup unit 12 also receives the vertex coordinates (x₀, y₀), (x₁, y₁) and (x₂, y₂) and determines the common terms k₁₁, k₁₂, k₂₁ and k₂₂ according to equation (7). The attribute setup/shading units 400 of the shading circuit 40 each receive the common terms (k₁₁, k₁₂, k₂₁ and k₂₂), the coordinates (x_{ref}, y_{ref}) of the reference pixel, the attribute values of the vertices and the coordinate (x, y) ready to be processed and determines an attribute value Λ(x, y) of the pixel (x, y).

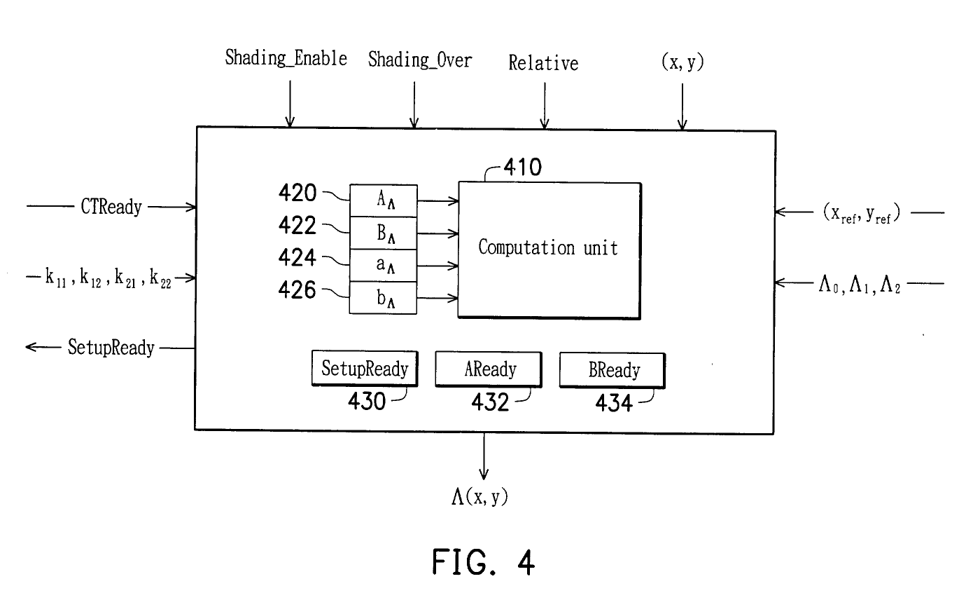

The attribute setup/shading unit 400 in the present embodiment is described here in detail. FIG. 4 is a block diagram of the attribute setup/shading unit 400 in the first embodiment of the present invention. As shown in FIG. 4, each attribute setup/shading unit 400 includes a computation unit 410, registers 420 and 422 for storing the coefficients A_{Λ} and B_{Λ} of the plane equation pertaining to the attribute surface of the current triangle, registers 424 and 426 for storing the coefficients a_{Λ} and b_{Λ} of the plane equation pertaining to the attribute surface of the next triangle and several status registers 430, 432 and 434 for storing flags SetupReady, AReady and BReady. The computation unit 410 is used to compute the coefficients of the plane equations and the attribute values, which will be described later. Flags SetupReady, AReady and BReady indicate if the calculation of the coefficients a_{Λ} and b_{Λ} of the plane equation pertaining to the attribute surface of the next triangle is completed.

In addition, the attribute setup/shading unit 400 receives control signals and data from the common term setup unit 12 and the shading coordinate generator 30. Except for the common terms k₁₁, k₁₂, k₂₁ and k₂₂, the coordinates of the reference pixel (x_{ref}, y_{ref}) (in the following discussion, (x_{ref}, y_{ref}) is set as (x₀, y₀)), and the vertex attribute values Λ₀, Λ₁ and Λ₂, the external signals of the attribute setup/shading unit 400 from the common term setup unit 12 include a control signal CTReady, which indicates that the common terms have been prepared already. In addition, except for the pixel coordinate (x, y), the external signals of the attribute setup/shading unit 400 from the shading coordinate generator 30 include control signals Shading_Over, Shading_Enable and Relative. The control signal Shading_Over informs the attribute setup/shading unit 400 whether the shading stage of the current triangle is finished. The control signal Shading_Enable indicates whether the attribute setup/shading unit should perform shading or not at this time. The control signal Relative indicates whether the shading style is absolute or relative.

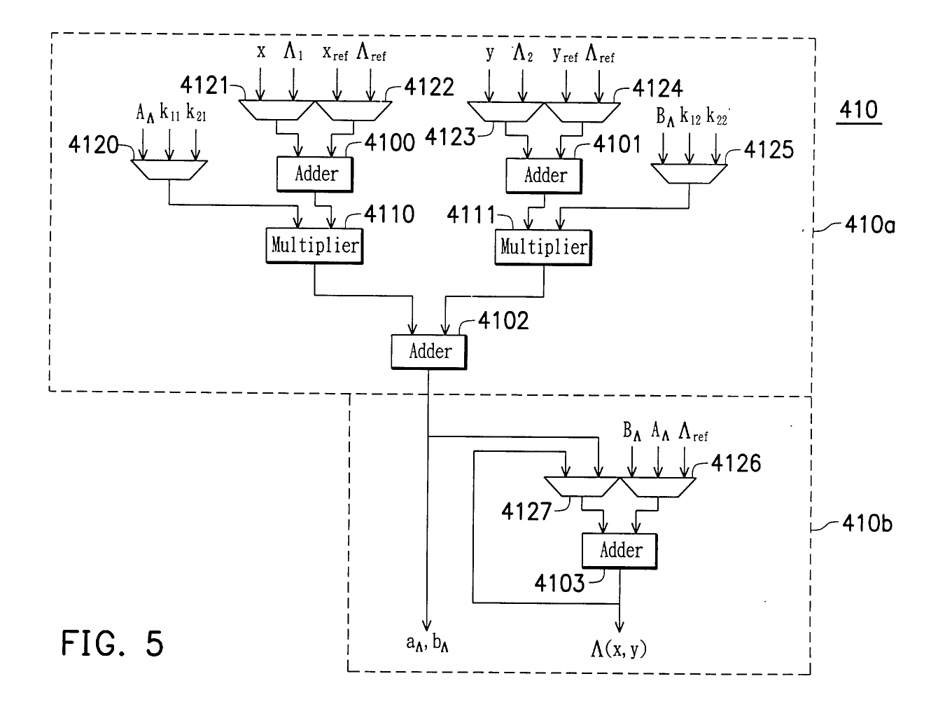

FIG. 5 is a circuit diagram of the computation unit 410 shown in FIG. 4. The computation unit 410 mainly includes four adders 4100˜4103 and two multipliers 4110˜4111. In addition, the computation unit 410 includes multiplexers 4120˜4127, used to switch the functions of calculating the coefficients of the plane equation and attribute values. As shown in FIG. 5, the computation unit 410 can be divided into two hardware sections 410a and 410b.

As the computation unit 410 calculates the attribute value using the absolute shading procedure, two hardware sections 410a and 410b are required. At this time, the outputs of these multiplexers are:

Multiplexer 4120: coefficient A_{Λ};

Multiplexer 4121: coordinate x of the current pixel;

Multiplexer 4122: coordinate x_{ref} of the reference pixel;

Multiplexer 4123: coordinate y of the current pixel;

Multiplexer 4124: coordinate y_{ref} of the reference pixel;

Multiplexer 4125: coefficient B_{Λ};

Multiplexer 4126: attribute value Λ_{ref} of the reference pixel; and

Multiplexer 4127: the output of adder 4102, expressed by A_{Λ}(x−x_{ref})+B_{Λ}(y−y_{ref}).

Thus, according to equation (8), the output of adder 4103 is the attribute value Λ(x, y) of the current pixel.

As the computation unit 410 calculates the attribute value using the relative shading procedure, only the hardware section 410b is required. At this time, the attribute value of the previous pixel is fed back to an input terminal of the multiplexer 4127 and multiplexer 4127 choose this input terminal. In addition, multiplexer 4126 chooses the coefficient A_{Λ} and B_{Λ} based on the relation between the current pixel and the previous pixel. Adder 4103, according to equations (9)˜(12), adds or subtracts the output of multiplexer 4127 to or from the output of multiplexer 4126 to produce the attribute value Λ(x, y) of the current pixel. On the other hand, the hardware section 410a is not utilized and can be used to calculate the coefficients a_{Λ} and b_{Λ} of the plane equation pertaining to the next triangle when the common terms k₁₁, k₁₂, k₂₁ and k₂₂ and the attribute values of the vertices Λ₀, Λ₁ and Λ₂ are ready. At this time, the outputs of these multiplexers in the hardware section 410a are:

Multiplexer 4120: common term k₁₁ or k_{21;}

Multiplexer 4121: attribute value Λ₁;

Multiplexer 4122: attribute value Λ_{ref} (i.e. Λ₀);

Multiplexer 4123: attribute value Λ₂;

Multiplexer 4124: attribute value Λ_{ref} (i.e. Λ₀); and

Multiplexer 4125: common term k₁₂ or k₂₂.

Thus, the output of adder 4102 is the coefficient a_{Λ}(i.e. k₁₁(Λ₁−Λ_{ref})+k₁₂(Λ₂−Λ_{ref})) or b_{Λ}(i.e. k₂₁(Λ₁−Λ_{ref})+k₂₂ (Λ₂−Λ_{ref})). According to the above description, each of the attribute setup/shading units 400 can simultaneously calculate the coefficients of the plane equation and the attribute value of the corresponding pixel under the control of these multiplexers.

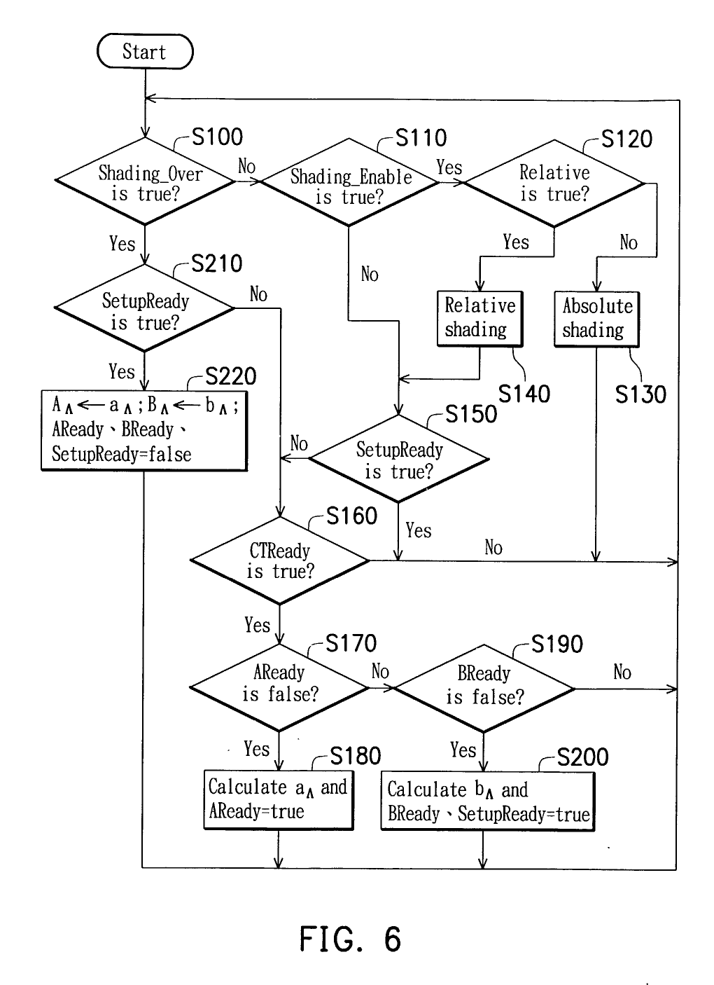

FIG. 6 is a flowchart illustrating the operation of the attribute setup/shading unit 400 in accordance with the first embodiment of the present invention, controlled by the control signal CTReady from the common term setup unit 12 and the control signals Shading_Over, Shading_Enable and Relative from the shading coordinate generator 30. If the signal Shading_Over is false (step S100) and the signal Shading_Enable is true (step S110), the shading process of all pixels of the current triangle is not completed and is continued. At this time, if the signal Relative is false (step S120), the pixel (x, y) is shaded by the absolute shading procedure (step S130). If the signal Relative is true (step S120), the pixel (x, y) is shaded by the relative shading procedure (step S140). When the relative shading procedure is activated (step S140) or the signal Shading_Enable, is false (step S110), the hardware section 410a is not required in the shading stage and can be used to calculate the coefficients of the plane equation of the next triangle. Thus, the flag SetupReady can be used to determine if the coefficients have been calculated (step S150). If no, the coefficients a_{Λ} and b_{Λ} of the plane equation of the next triangle are ready to be calculated. Subsequently, if the signal CTReady is true (step S160), the data of the common terms for the next triangle have been prepared. If the flag AReady is false (step S170), the coefficient a_{Λ} is calculated and the flag AReady is set at true (step S180). If the flag BReady is false (step S190), the coefficient b_{Λ} is calculated and the flags BReady and SetupReady are all set at true (step S200). It is noted that the hardware section 410b is generally used to perform the relative shading procedure.

On the other hand, if the control signal Shading_Over is true (step S100), it means that the calculation of the attribute values pertaining to all pixels within the current triangle has been completed. Thus, if the flag SetupReady is true (step S210), which means that the coefficients a_{Λ} and b_{Λ} of the next triangle have been prepared, the coefficients a_{Λ} and b_{Λ} stored in registers 424 and 426 can replace the coefficients A_{Λ and B}_{Λ} stored in registers 420 and 422 and the flags AReady, BReady and SetupReady are restored to be false (step S220) to proceed with the shading process of the next triangle.

Accordingly, the setup/shading device of the first embodiment can further simplify the circuitry of the conventional distributed architecture and lower the cost of implementing the distributed setup scheme while the high speed property of the distributed architecture still remains.

Second Embodiment

In the first embodiment, each attribute setup/shading unit only calculates the attribute value of a single pixel. In the present embodiment, the function of the attribute setup/shading unit is expanded to simultaneously process several pixels, called block shading. Each “block” can include two adjacent pixels, four pixels or n×m pixels. In the following discussion, the block size is set at four pixels for shading.

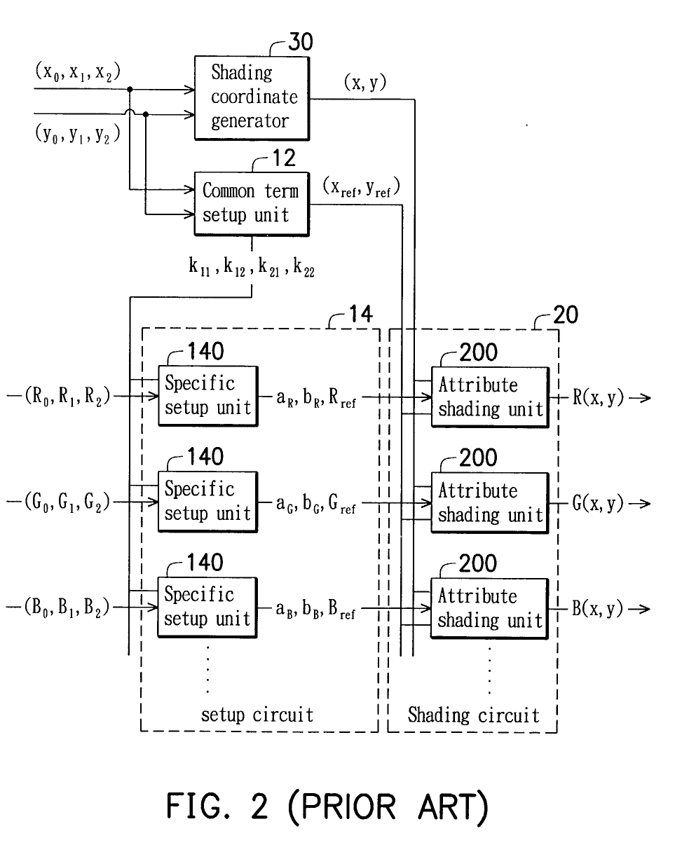

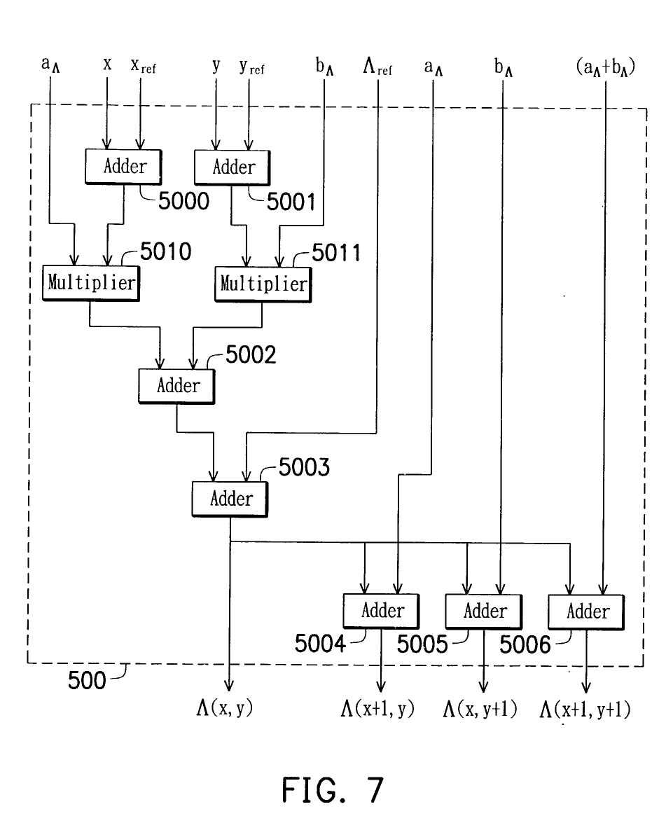

FIG. 7 is a circuit diagram of an attribute shading unit 500 in accordance with the second embodiment of the present invention, which can be applied to the conventional distributed architecture shown in FIG. 2 to process a block shading procedure of one attribute. The attribute shading unit 500 mainly includes seven adders 5000˜5006 and two multipliers 5010˜5011. As shown in FIG. 7, adders 5000˜5003 and the multipliers 5010˜5011 are used to calculate the attribute value Λ(x, y) of a pixel (x, y), that is, a_{Λ}(x−x_{ref})+b_{Λ}(y−y_{ref})+Λ_{ref}. In addition, according to equations (9) and (10), the attribute values of the other three pixels (x, y+1), (x+1, y) and (x+1, y+1) within the same block can be calculated by adders 5004˜5006, where Λ(x+1, y)=Λ(x, y)+a_{Λ}, Λ(x, y+1)=Λ(x, y)+b_{Λ} and Λ(x+1, y+1)=Λ(x, y)+(a_{Λ}+b_{Λ}). Thus, the attribute shading unit 500 can simultaneously produce the attribute values of the four pixels. It is noted that the shading coordinate generator 30 does not need to send the coordinates of all pixels within a block. Only one coordinate set of a pixel within the 2×2 block is sufficient for shading.

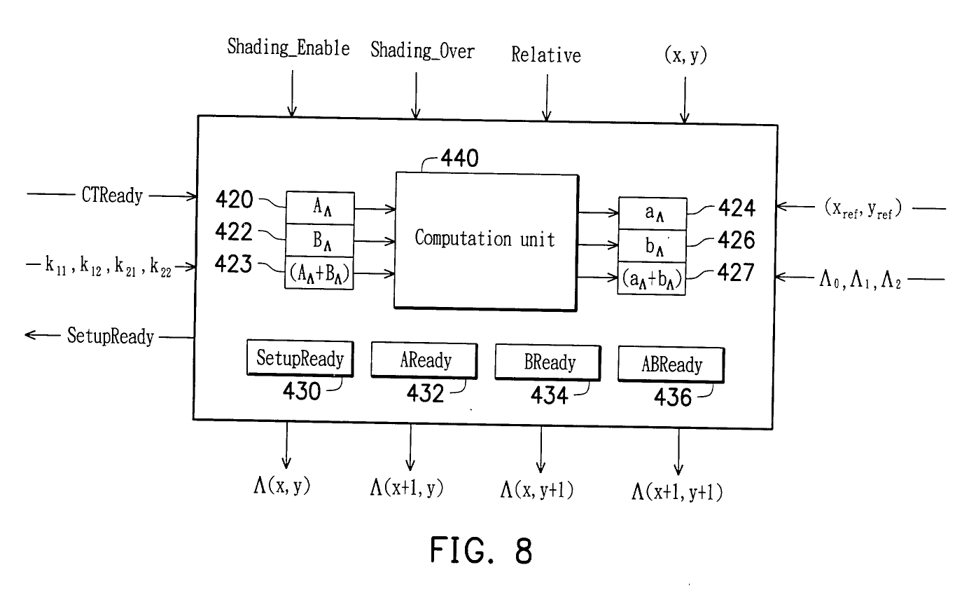

The block shading function also can be applied to the attribute setup/shading unit of the first embodiment. FIG. 8 is a block diagram of the attribute setup/shading unit 400 in the second embodiment of the present invention, different from that of FIG. 4 in the computation unit 400 and will be described later. In addition, the attribute setup/shading unit 400 of the present embodiment further includes two registers 423 and 427 for storing A_{Λ}+B_{Λ}, the sum of the coefficients of the plane equation corresponding to the attribute surface of the current triangle, and a_{Λ}+b_{Λ}, the sum of the coefficients of the plane equation corresponding to the attribute surface of the next triangle, used in the relative shading procedure in terms of the pixel (x+1, y+1). In addition, the attribute setup/shading unit 400 further includes a status register 436 for storing a flag ABReady for indicating whether the calculation of a_{Λ}+b_{Λ} is completed. Other building blocks and signals are the same as those in the first embodiment and will not be described again.

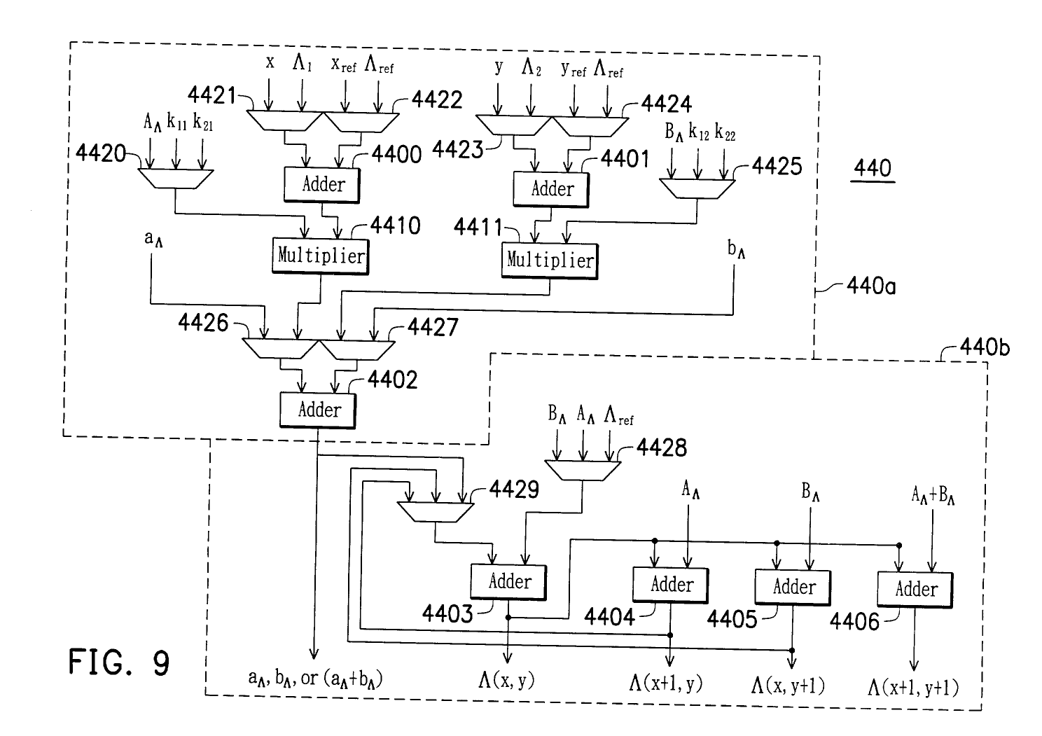

FIG. 9 is a circuit diagram of the computation unit 440 shown in FIG. 8. The computation unit 440 mainly includes seven adders 4400˜4406 and two multipliers 4410˜4411. In addition, multiplexers 4420˜4429 are used to switch the functions of calculating the coefficients of the plane equation and the attribute values of the pixels. Similarly, the computation unit 440 is divided into two hardware sections 440a and 440b, as shown in FIG. 9.

As the computation unit 440 calculates the attribute value of the pixel (x, y) of a block using the absolute shading procedure, two hardware sections 440a and 440b are required. At this time, the outputs of these multiplexers are:

Multiplexer 4420: coefficient A_{Λ};

Multiplexer 4421: coordinate x of the pixel (x, y);

Multiplexer 4422: coordinate x_{ref} of the reference pixel;

Multiplexer 4423: coordinate y of the pixel (x, y);

Multiplexer 4424: coordinate y_{ref} of the reference pixel;

Multiplexer 4425: coefficient B_{Λ};

Multiplexer 4426: the output of multiplier 4410;

Multiplexer 4427: the output of multiplier 4411;

Multiplexer 4428: attribute value Λ_{ref} of the reference pixel; and

Multiplexer 4429: the output of adder 4402, expressed by A_{Λ}(x−x_{ref})+B_{Λ}(y−y_{ref}).

Thus, according to equation (8), the output of adder 4403 is the attribute value Λ(x, y) of the pixel (x, y). Next, adders 4404, 4405 and 4406 add A_{Λ}, B_{Λ} and A_{Λ}+B_{Λ} to attribute value Λ(x, y), respectively, to produce the attribute values of other pixels, i.e. Λ(x+1, y), Λ(x, y+1) and Λ(x+1, y+1), within the same block.

As the computation unit 440 calculates the attribute value of the pixel (x, y) of a block using the relative shading procedure, only the hardware section 440b is required. At this time, the attribute values Λ(x+1, y) and Λ(x, y+1) of the pixels (x+1, y) and (x, y+1) of the previously processed block are fed back to input terminals of the multiplexer 4129, which can choose one of the input terminals. It is noted that in the present embodiment the attribute values of the pixels (x+1, y) and (x, y+1) of the previously processed block are applied to the relative shading pertaining to the pixel (x, y) of the current block, not intended to limit the scope of the present invention. In addition, multiplexer 4428 chooses the coefficient A_{Λ and B}_{Λ} based on the relation between the pixel (x, y) of the current block and the chosen pixel of the previous block. According to equations (9)˜(12), adder 4403 adds or subtracts the output of multiplexer 4429 to or from the output of multiplexer 4428 to produce the attribute value Λ(x, y) of the pixel (x, y) of the current block. Next, adders 4404, 4405 and 4406 output the attribute values of other pixels, i.e. Λ(x+1, y), Λ(x, y+1) and Λ(x+1, y+1), within the same block. Since the hardware section 440a is now idle, it can be used to calculate the coefficients a_{Λ} and b_{Λ} of the plane equation pertaining to the next triangle and the sum a_{Λ}+b_{Λ} when the common terms k₁₁, k₁₂, k₂₁ and k₂₂ and the attribute values of the vertices Λ₀, Λ₁ and Λ₂ have been sent to attribute setup/shading unit 400. When the coefficients a_{Λ} and b_{Λ} are being calculated, the outputs of these multiplexers in the hardware section 440a are:

Multiplexer 4420: common term k₁₁ or k₂₁;

Multiplexer 4421: attribute value Δ₁;

Multiplexer 4422: attribute value Λ_{ref} (i.e. Λ₀);

Multiplexer 4423: attribute value Λ₂;

Multiplexer 4424: attribute value Λ_{ref} (i.e. Λ₀);

Multiplexer 4425: common term k₁₂ or k₂₂;

Multiplexer 4426: the output of multiplier 4410; and

Multiplexer 4427: the output of multiplier 4411.

Thus, the output of adder 4402 is the coefficient a_{Λ} (i.e. k₁₁ (Λ₁−Λ_{ref})+k₁₂(Λ₂−Λ_{ref})) or b_{Λ}(i.e. k₂₁ (Λ₁−Λ_{ref})+k₂₂ (Λ₂−Λ_{ref})). In terms of the sum a_{Λ}+b_{Λ}, the multiplexer 4426 outputs the coefficient a_{Λ} and the multiplexer 4427 outputs the coefficient b_{Λ} and thus the output of adder 4402 is a_{Λ}+b_{Λ}. According to the above description, the attribute setup/shading unit 400 with the block shading function, like that in the first embodiment, can simultaneously calculate the coefficients of the plane equation and the attribute values of the pixels utilizing the same circuitry.

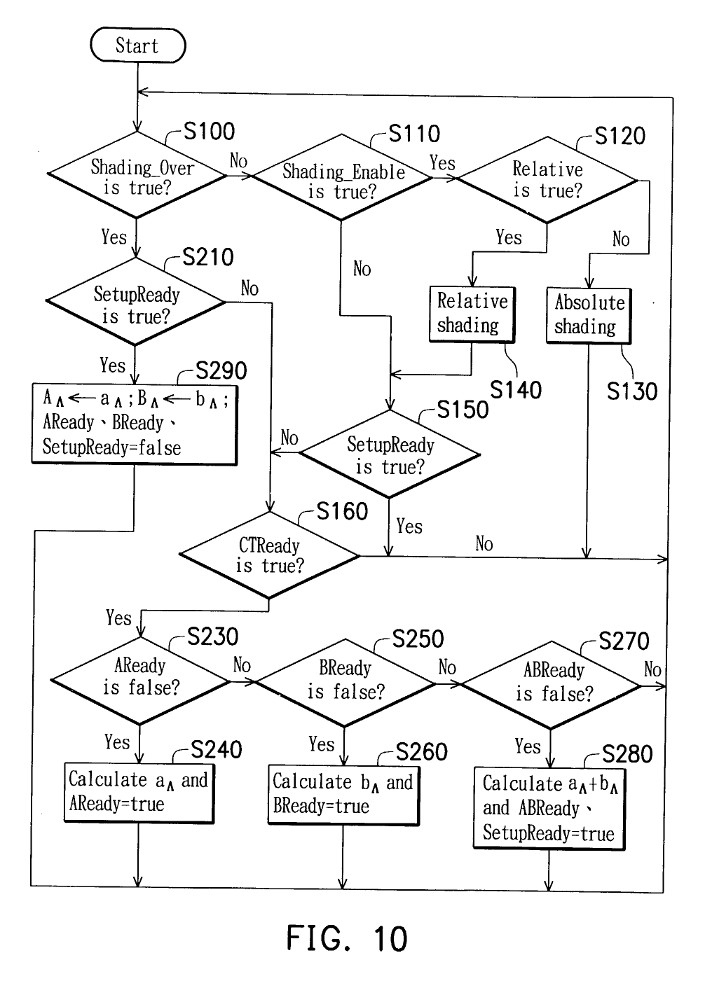

FIG. 10 is a flowchart illustrating the operation of the attribute setup/shading unit 400 in accordance with the second embodiment of the present invention, still controlled by the control signal CTReady from the common term setup unit 12 and the control signals Shading_Over, Shading_Enable and Relative from the shading coordinate generator 30. If the signal Shading_Over is false (step S100) and the signal Shading_Enable is true (step S110), the shading process of all pixels of the current triangle is not completed and is continued. At this time, if the signal Relative is false (step S120), the pixel (x, y) is shaded by the absolute shading procedure and other pixels of the same block are shaded by the relative shading procedure (step S131). If the signal Relative is true (step S120), the pixel (x, y) and other pixels of the current block are all shaded by the relative shading procedure (step S140). When the relative shading procedure in step S140 is activated or the signal Shading_Enable is false, the hardware section 440a is not required in the shading stage and can be used to calculate the coefficients of the plane equation of the next triangle. Thus, the flag SetupReady can be used to determine if the coefficients have been calculated (step S150). If no, the coefficients a_{Λ} and b_{Λ} of the plane equation of the next triangle and their sum a_{Λ}+b_{Λ} are ready to be calculated. Subsequently, if the signal CTReady is true (step S160), the data of the common terms for the next triangle have been prepared. Next, the flags AReady, BReady and ABReady are verified (steps S230, S250 and S270). If the coefficient a_{Λ} has not been calculated yet, the hardware section 440a is used to calculate the coefficient a_{Λ} and the flag AReady is set at true (step S240). If the coefficient b_{Λ} has not been calculated yet, the hardware section 440a is used to calculate the coefficient b_{Λ} and the flag BReady is set at true (step S260). If the sum a_{Λ}+b_{Λ} has not been calculated yet, the hardware section 440a is employed to calculate it and the flags ABReady and SetupReady are set at true (step S280). It is noted that now the hardware section 410b is generally used to perform block shading by the relative shading procedure.

On the other hand, if the control signal Shading_Over is true (step S100), it means that the calculation of the attribute values pertaining to all pixels within the current triangle has been completed. Thus, if the flag SetupReady is true (step S210), which means that the coefficients a_{Λ} and b_{Λ} and their sum a_{Λ}+b_{Λ} have been prepared, the coefficients a_{Λ} and b_{Λ} stored in registers 424 and 426 and the sum a_{Λ}+b_{Λ} stored in register 427 can replace the coefficients A_{Λ and B}_{Λ} stored in registers 420 and 422 and the sum A_{Λ}+B_{Λ} stored in register 423. In addition, the flags AReady, BReady, ABReady and SetupReady are restored to be false (step S290) to proceed with the shading process of the next triangle.

Accordingly, the setup/shading device with block shading in the second embodiment does not only simplify the circuitry of the conventional distributed architecture, but also speeds up the calculating operations by block shading.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims is accorded the broadest interpretation so as to encompass all such modifications and similar arrangements.

What is claimed is:

1. A device for performing a shading process in respect to an attribute of a graphical object for determining attribute values of pixels within the graphical object based on a plane equation corresponding to the attribute, comprising:
a shading coordinate generator for sequentially producing coordinates of the pixels contained in the graphical object;
a common term setup unit for determining a plurality of common term data, independent of the attribute, contained in coefficients of the plane equation; and
an attribute setup/shading unit, corresponding to the attribute and coupled to the shading coordinate generator and the common term setup unit, for calculating the coefficients of the plane equation based on the common term data and calculating the attribute values of the pixels corresponding to the coordinates received from the shading coordinate generator based on the plane equation using the same hardware circuitry under the control of a plurality of multiplexers.

2. The device as recited in claim 1, wherein the graphical object is a triangle.

3. The device as recited in claim 1, wherein the attribute comprises color components, depth information, blending factors, or texture coordinates.

4. The device as recited in claim 1,
wherein all the pixels of the graphical object are allotted to a plurality of blocks;
wherein the shading coordinate generator sequentially produces the coordinates of at least one of the pixels allotted in each of the blocks; and
wherein the attribute setup/shading unit employs a relative shading procedure to calculate the attribute values of other pixels allotted in each of the blocks after receiving the coordinates from the shading coordinate generator.

5. A device for performing a shading process in respect to an attribute of a first graphical object for determining attribute values of pixels within the first graphical object based on a first plane equation corresponding to the attribute, comprising:
a shading coordinate generator for sequentially producing coordinates of the pixels contained in the first graphical object;
a common term setup unit for determining first common term data and second common term data, independent of the attribute, contained in coefficients of the first plane equation and coefficients of a second plane equation corresponding to a second graphical object subsequent to the first graphical object; and
an attribute setup/shading unit, corresponding to the attribute and including a first hardware circuit and a second hardware circuit, for calculating the coefficients of the first and second plane equations based on the first and second common term data, respectively, and calculating the attribute values of the pixels according to the coordinates received from the shading coordinate generator and the first plane equation, the attribute setup/shading unit being operated in a first mode, in which the first hardware circuit and the second hardware circuit calculate the attribute values of the pixels of the first graphical object, or a second mode, in which the second hardware circuit calculates the attribute values of the pixels of the first graphical object and the first hardware circuit calculates the coefficients of the second plane equation corresponding to the second graphical object.

6. The device as recited in claim 5, wherein the first and second graphical objects are triangles.

7. The device as recited in claim 5, wherein the attribute comprises color components, depth information, blending factors, or texture coordinates.

8. The device as recited in claim 5, wherein the first mode employs an absolute shading procedure and the second mode employs a relative shading procedure.

9. The device as recited in claim 5, wherein the attribute setup/shading unit has a register storing the coefficients of the second plane equation corresponding to the second graphical object.

10. The device as recited in claim 5,
wherein all the pixels of the first graphical object are allotted to a plurality of blocks;
wherein the shading coordinate generator sequentially produces the coordinates of at least one of the pixels allotted in each of the blocks; and
wherein the attribute setup/shading unit employs a relative shading procedure to calculate the attribute values of other pixels allotted in each of the blocks after receiving the coordinates from the shading coordinate generator.

11. The device as recited in claim 10, wherein the relative shading procedure of calculating the attribute values of other pixels allotted in each of the block is performed by the second hardware circuit.

12. The device as recited in claim 5, wherein the first hardware circuit and the second hardware circuit include a plurality of multiplexers for controlling the switching of the first mode and the second mode.

13. The device as recited in claim 5, wherein the coefficients of each of the first and second plane equations include a first coefficient and a second coefficient.

14. A device for performing a shading process in respect to an attribute of a graphical object for determining attribute values of pixels within the graphical object based on a plane equation corresponding to the attribute, comprising:
a shading coordinate generator for sequentially producing coordinates of at least one of the pixels allotted in each of a plurality of blocks within the graphical object;
a setup circuit for determining coefficients of the plane equation; and
an attribute shading unit, corresponding to the attribute and coupled to the shading coordinate generator and the setup circuit, for calculating the attribute values of the pixels corresponding to the coordinates received from the shading coordinate generator based on the plane equation and calculating the attribute values of other pixels in the blocks by a relative shading procedure.

15. The device as recited in claim 14, wherein the graphical object is a triangle.

16. The device as recited in claim 14, wherein the attribute comprises color components, depth information, blending factors, or texture coordinates.

17. A method of performing a shading process in respect to an attribute of a first graphical object for determining attribute values of pixels within the first graphical object based on a first plane equation corresponding to the attribute, comprising the steps of:
sequentially producing coordinates of at least an initial pixel of the pixels contained in the first graphical object;
determining common term data, independent of the attribute, contained in coefficients of a second plane equation corresponding to a second graphical object subsequent to the first graphical object;
calculating the attribute value of the initial pixel according to the coordinates of the initial pixel and the first plane equation corresponding to the first graphical object by an absolute shading procedure; and
simultaneously calculating the attribute values of the pixels of the first graphical object according to the attribute value of the initial pixel by a relative shading procedure and calculating the coefficients of the second plane equation according to the common term data.

18. The method as recited in claim 17, wherein the first and second graphical objects are triangles.

19. The method as recited in claim 17, wherein the attribute comprises color components, depth information, blending factors, or texture coordinates.

20. The method as recited in claim 17, wherein the step of calculating the attribute values of the pixels by the relative shading procedure is performed by a second hardware circuit, the step of calculating the coefficients of the second plane equation is performed by a first hardware circuit and the step of calculating the attribute value of the initial pixel by the absolute shading procedure is performed by the first hardware circuit and the second hardware circuit.
